(19) United States
(12) Patent Application Publication
(10) Pub. No.: US 2007/0155898 A1
(43) Pub. Date: Jul. 5, 2007

(54) Thermoplastic resin composition with low coefficient of linear thermal expansion

(76) Inventors: Hee Seok Na, Incheongwangyeok-si (KR); Tae Uk Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/598,541

(22) Filed: Nov. 13, 2006

Related U.S. Application Data
(63) Continuation-in-part of application No. PCT/KR04/01777, filed on Jul. 16, 2004.

(30) Foreign Application Priority Data
May 13, 2004 (KR) 10-2004-0033922

(51) Int. Cl. C08L 51/00

(52) U.S. Cl. 525/67

(57) ABSTRACT

The present invention relates to polymeric materials. More particularly, the present invention relates to a thermoplastic resin composition, a method of making a thermoplastic resin composition and an article made from a thermoplastic resin composition.

### CROSS-REFERENCE TO RELATED APPLICATIONS

This application is a continuation-in-part application under 35 U.S.C. § 365(c) of International Application No. PCT/KR2004/001777, filed Jul. 16, 2004, designating the United States. International Application No. PCT/KR2004/001777 was published in English as WO 2005/111147 A1 on Nov. 24, 2005. This application further claims for the benefit of the earlier filing dates under 35 U.S.C. § 365(b) of Korean Patent Application No. 10-2004-0033922 filed May 13, 2004. This application incorporates herein by reference the International Application No. PCT/KR2004/001777 including WO 2005/111147 A1 and the Korean Patent Application No. 10-2004-0033922 in their entirety.

### BACKGROUND

1. Field

The present invention relates to polymeric materials. More particularly, the present invention relates to a thermoplastic resin composition, a method of making a thermoplastic resin composition and an article made from a thermoplastic resin composition.

2. Discussion of Related Technology

A styrenic thermoplastic resin is excellent in impact resistance, mechanical strength, appearance and mold processability, therefore, the resin has been widely applied to electric/electronic appliances, interior/exterior parts of automobiles and household products. In particular, when styrenic resin is used for interior/exterior parts of automobiles that may be connected to metal, and especially when used for exterior parts exposed to extreme changes in temperature and weather or used for relatively large-sized parts of automobiles, not only mechanical strength, but also good heat resistance and dimensional stability are required.

When the heat resistance is insufficient, the molded article of the resin composition tends to be deformed and crooked at high temperature. And when the dimensional stability is insufficient, the molded article of the resin composition may not fit to other parts during assembly and may be deformed and distorted, or cracks may sometimes take place under temperature conditions that change frequently. Therefore, heat resistance and dimensional stability are highly required for use in the parts of automobiles. Especially, the molded articles assembled to metal parts may be more easily deformed after assembly upon changes in temperature even though they fit to other parts at the time of assembly.

The reason for this is that the coefficient of linear thermal expansion of the resin is about 4-8 times higher than that of metal. Accordingly, it is desirable to produce resins having a coefficient of linear thermal expansion similar to that to that of the metal.

Typically, inorganic fillers are used to achieve a low coefficient of linear thermal expansion of resin. However, resin compositions containing a lot of inorganic fillers generally have poor impact strength and surface appearance. The foregoing discussion in this section is solely to provide background information and does not constitute an admission of prior art.

### SUMMARY

One aspect of the invention provides a thermoplastic resin composition. The thermoplastic resin composition can comprises a diene graft polymer comprising a diene rubber grafted with polymeric chains of at least one of a vinyl cyanide monomer and a vinyl aromatic monomer, a first vinyl cyanide-vinyl aromatic copolymer group having a weight average molecular weight from about 100,000 to 200,000, a second vinyl cyanide-vinyl aromatic copolymer group having a weight average molecular weight from 200,000 to about 600,000; and an N-substituted maleimide copolymer.

The amounts of the components in the thermoplastic resin composition of can be as follows: the diene graft polymer can be from about 15% to about 30% by weight with reference to the total weight of the composition, the total amount of the first and second vinyl cyanide-vinyl aromatic copolymer groups can be from about 40% to about 84% by weight with reference to the total weight of the composition, the N-substituted maleimide copolymer can be from about 1% to about 30% by weight with reference to the total weight of the composition, and the weight ratio of the first vinyl cyanide-vinyl aromatic copolymer group to the second vinyl cyanide-vinyl aromatic copolymer group can be less than about 4

Another aspect of the invention relates to a method of preparing the foregoing thermoplastic resin composition. The components of the resin composition can be contacted or mixed together sufficient to form a resin composition mixture. The components can be mixed in a batch mixer or an extruder to form a resin composition mixture. After mixing, the composition can be molded and cured in such a manner to produce various plastic products.

Another aspect of the present invention involves a molded article made from the thermoplastic resin composition described above. Various products can be formed from the material described herein, including structural parts of automobiles and household appliances.

A molded article made from the thermoplastic resin composition described herein can have unique properties. A portion of a molded article made from the composition described herein can have an Izod impact strength of at least about 8.5, 9, 10, 11, 12, 14, 16, 18 or 20 kgf·cm/cm when measured according to the standard ASTM D256 (¼″ notched) at 23° C.

A portion of a molded article made from the composition described herein can have a coefficient of linear thermal expansion smaller than about 74, 72, 70, 68 or 66 μm/·° C. when measured using a thermomechanical analyzer (TMA) under temperature varying from 30° C. to 80° C. at the rate of 10° C./min.

A portion of a molded article made from the composition described herein can have a total content of volatile organic compound (TVOC) smaller than about 300, 250, 200, or 150 ppm when measured using gas chromatography under VDA 277.

### DETAILED DESCRIPTION OF EMBODIMENTS

As noted above, one aspect of this invention relates to a thermoplastic resin composition. According to various embodiments, the resin composition comprises a diene graft polymer, a first vinyl cyanide-vinyl aromatic copolymer group having a first weight average molecular weight, a second first vinyl cyanide-vinyl aromatic copolymer group having a second weight average molecular weight and an N-substituted maleimide copolymer. The composition can optionally include additives such as oxidation inhibitors, lubricants, impact modifiers, light stabilizers, fillers and pigments. The resin composition can be used to form various products, including structural parts for automobiles and household appliances. The molded articles of the embodiments demonstrate low coefficient of linear thermal expansion, excellent impact resistance and heat resistance, as well as a decreased VOC content. A more detailed description of the components of the resin composition according to various embodiments of the present invention follows.

Diene Graft Polymer

In various embodiments, the diene graft polymer can comprise a rubber polymer grafted with polymer or copolymer side chains.

According to embodiments, examples of the rubber polymer include diene rubber, acrylic rubber, silicone rubber and urethane rubber. According to embodiments, examples of diene rubber include polybutadiene, polyisoprene, polychloroprene, a butadiene-styrene copolymer, a butadiene-acrylonitrile copolymer, butyl rubber, an acrylonitrile-styrene-butadiene copolymer, an ethylene-propylene copolymer, a styrene-isoprene copolymer, a styrene-isoprene-butadiene copolymer, an isoprene-butadiene copolymer. Among them, polybutadiene, a butadiene-styrene copolymer, and a butadiene-acrylonitrile copolymer may be preferably used.

The polymer or copolymer side chains can be grafted onto the diene rubber by methods known in the art. Various polymerization techniques can be used including emulsion polymerization, bulk polymerization, emulsion-suspension polymerization, emulsion-bulk polymerization, emulsion-solution polymerization and micro-suspension polymerization.

In some embodiments of the present invention, the graft ratio of grafting the polymer or copolymer matrix onto the diene rubber can be about 40%, 45%, 50%, 55%, 60%, 65% or 70% based upon the weight of the diene graft polymer. Further, according to some embodiments of the present invention, the graft ratio of grafting the polymer matrix onto the diene rubber can be in a range from about any of the foregoing amounts to any other of the foregoing amounts. The average rubber particle size of the diene rubber is preferably in the range of about 0.1 μm to about 0.6 μm, including from about 0.2 μm to about 0.5 μm and 0.3 μm to about 0.4 μm.

The side chains can comprise polymer or copolymer moieties or chains attached to the rubber particles or cores. The polymer or copolymer side chains can be prepared by polymerizing monomer compounds including vinyl cyanide compounds and vinyl aromatic compounds.

The polymer or copolymer moieties or chains can be prepared via polymerization techniques known in the art including emulsion polymerization, bulk polymerization, emulsion-suspension polymerization, emulsion-bulk polymerization, emulsion-solution polymerization and micro-suspension polymerization.

In some embodiments, the side chains can be prepared by polymerizing a monomer mixture comprising vinyl cyanide compounds and vinyl aromatic compounds. Polymerizing such a mixture can result in polymer moieties or chains comprising polymerized vinyl cyanide monomer units, polymer moieties or chains comprising polymerized vinyl aromatic monomer units and copolymer moieties or chains comprising a mixture of polymerized vinyl cyanide and vinyl aromatic monomer units. The copolymer moieties or chains can comprise block copolymer comprising blocks of polymerized vinyl cyanide monomer units and vinyl aromatic monomer units. In addition, the copolymer moieties or chains can comprise alternating copolymers and random copolymers.

Examples of the vinyl cyanide compound according to embodiments include acrylonitrile, methacrylonitrile and combinations thereof. Examples of the vinyl aromatic compound according to embodiments of the present invention include styrene, alpha-methylstyrene, o-methylstyrene, p-methylstyrene, m-methylstyrene, p-t-butylstyrene, 2,4-dimethylstyrene, 2,4,6-trimethylstyrene, vinyltoluene, 1-vinylnapthalene, 2-vinylnapthalene, vinylanthracene, 1,3-dimethylstyrene, and combinations thereof.

In some embodiments, the vinyl cyanide compound can comprise about 20%, 22%, 24%, 26%, 28% or 30% by weight with reference to the total weight of the monomer mixture comprising vinyl cyanide monomers and vinyl aromatic monomers. Further, according to some embodiments, the vinyl cyanide compound can comprise a weight percentage of the monomer mixture in a range from about any of the foregoing amounts to about any other of the foregoing amounts.

In some embodiments, the vinyl aromatic compound can comprise about 70%, 72%, 74%, 76%, 78% or 80% by weight with reference to the total weight of the monomer mixture comprising vinyl cyanide monomers and vinyl aromatic monomers. Further, the vinyl aromatic compound can comprise a weight percentage of the monomer mixture in a range from about any of the foregoing amounts to any of the other foregoing amounts.

In some embodiments, the monomer mixture comprising vinyl cyanide monomers and vinyl aromatic monomers can comprise about 40%, 45%, 50%, 55% or 60% by weight with reference to the total weight of the diene rubber. Further, according to some embodiments of the present invention, the monomer mixture comprising vinyl cyanide monomers and vinyl aromatic monomers can comprise an amount with reference to the total weight of the diene rubber in the range of about any of the foregoing amounts to about any of the other foregoing amounts.

In some embodiments, the diene graft polymer can comprise about 10%, 12%, 15%, 17%, 19%, 21%, 23%, 25%, 27%, 29% 30%, 32% Or 35% by weight with reference to the total weight of the thermoplastic resin composition. Further, according to some embodiments of the present invention, the diene graft polymer can comprise a weight percentage of the thermoplastic resin composition in a range from about any of the foregoing amounts to about any other of the foregoing amounts.

Vinyl Cyanide-Vinyl Aromatic Copolymer Groups

In various embodiments, the vinyl cyanide-vinyl aromatic copolymer groups comprise a group of vinyl cyanide-vinyl aromatic polymers or copolymers. Each vinyl cyanide-vinyl aromatic copolymer group can differ in the weight average molecular weight of the vinyl cyanide-vinyl aromatic polymers or copolymers of the group.

The vinyl cyanide-vinyl aromatic polymers or copolymers of the vinyl cyanide-vinyl aromatic copolymer groups can be prepared by polymerizing a monomer mixture comprising vinyl cyanide compounds and vinyl aromatic compounds. Polymerizing the monomer mixture comprising vinyl cyanide compounds and vinyl aromatic compounds can result in polymer moieties or chains comprising polymerized vinyl cyanide monomer units, polymer moieties or chains comprising polymerized vinyl aromatic monomer units and copolymer moieties or chains comprising a mixture of polymerized vinyl cyanide and vinyl aromatic monomer units. The copolymer moieties or chains can comprise block copolymer comprising blocks of polymerized vinyl cyanide monomer units and vinyl aromatic monomer units. In addition, the copolymer moieties or chains can comprise alternating copolymers and random copolymers.

The monomer mixture comprising vinyl cyanide compounds and vinyl aromatic compounds can be polymerized using techniques known in the art including emulsion polymerization, bulk polymerization, emulsion-suspension polymerization, emulsion-bulk polymerization, emulsion-solution polymerization and micro-suspension polymerization.

Examples of the vinyl cyanide compound according to embodiments include acrylonitrile, methacrylonitrile and combinations thereof. Examples of the vinyl aromatic compound according to embodiments include styrene, alpha-methylstyrene, o-methylstyrene, p-methylstyrene, m-methylstyrene, p-t-butylstyrene, 2,4-dimethylstyrene, 2,4,6-trimethylstyrene, vinyltoluene, 1-vinylnapthalene, 2-vinylnapthalene, vinyl anthracene, 1,3-dimethylstyrene, and combinations thereof.

In some embodiments, the vinyl cyanide compound can comprise about 20%, 25%, 30%, 35% or 40% by weight with reference to the total weight of the vinyl cyanide-vinyl aromatic copolymer group. Further, according to some embodiments, the vinyl cyanide compound can comprise a weight percentage of the vinyl cyanide-vinyl aromatic copolymer group in the range from about any of the foregoing amounts to about any of the other foregoing amounts.

In some embodiments, the vinyl aromatic compound can comprise about 60%, 65%, 70%, 75% or 80% by weight of the vinyl cyanide-vinyl aromatic copolymer group. Further, according to some embodiments, the vinyl aromatic compound can comprise a weight percentage of the vinyl cyanide-vinyl aromatic copolymer group in the range from about any of the foregoing amounts to any other of the foregoing amounts.

As mentioned above, the vinyl cyanide-vinyl aromatic copolymer groups can differ in the weight average molecular weight of the vinyl cyanide-vinyl aromatic polymers or copolymers in the group. In some embodiments, a first vinyl cyanide-vinyl aromatic copolymer group can comprise a weight average molecular weight of about 100,000, 120,000, 130,000, 140,000, 150,000, 160,000, 170,000, 180,000, 190,000 or 200,000. Further, according to some embodiments, a first vinyl cyanide-vinyl aromatic copolymer can comprise a weight average molecular weight in the range of about any of the foregoing amounts to any other of the foregoing amounts.

In some embodiments, a second vinyl cyanide-vinyl aromatic copolymer group can comprise a weight average molecular weight of about 200,000, 250,000, 300,000, 350,000, 400,000, 450,000, 500,000, 550,000 or 600,000. Further, according to some embodiments of the present invention, the other vinyl cyanide-vinyl aromatic copolymer of the vinyl cyanide-vinyl aromatic copolymer mixture can comprise a weight average molecular weight in the range of about any of the foregoing amounts to any other of the foregoing amounts.

According to embodiments comprising a combination of two vinyl cyanide-vinyl aromatic copolymer groups, the weight ratio between the two vinyl cyanide-vinyl aromatic copolymer groups can vary over a wide range. In some embodiments, the weight ratio between the groups can comprise about 0.1, 0.2, 0.3, 0.4, 0.5, 0.6, 0.7, 0.8, 0.9, 1, 1.5, 2, 2.5, 3, 3.5 or 4. In addition, in some embodiments, the weight ratio between the groups can comprise a number in the range from about any of the foregoing amounts to about any other of the foregoing amounts.

In some embodiments, the total amount of the first and second vinyl cyanide-vinyl aromatic copolymer groups can comprise about 35%, 40%, 45%, 50%, 55%, 60%, 65%, 70%, 75%, 80%, 84% or 90% by weight with reference to the total weight of the thermoplastic resin composition. Further, according to some embodiments of the present invention, the total amount of the first and second vinyl cyanide-vinyl aromatic copolymer groups can comprise a weight percentage of the thermoplastic resin composition in a range from about any of the foregoing amount to about any other of the foregoing amounts.

N-Substituted Maleimide Copolymer

In various embodiments, the N-substituted maleimide copolymer is a polymer or copolymer comprising polymerized monomer units of maleic anhydride and at least one type of N-substituted maleimide. In addition, the N-substituted maleimide copolymer can further comprise polymerized monomer units of a vinyl aromatic compound and/or a vinyl cyanide compound.

In some embodiments of the present invention, the N-substituted maleimide copolymer can be prepared by polymerizing a mixture comprising maleic anhydride and at least one type of N-substituted maleimide and a mixture comprising a vinyl aromatic compound and/or a vinyl cyanide compound.

The two mixtures can be polymerized to form the N-substituted maleimide copolymer using techniques known in the art including emulsion polymerization, bulk polymerization, emulsion-suspension polymerization, emulsion-bulk polymerization, emulsion-solution polymerization and micro-suspension polymerization.

Polymerizing the two mixtures can result in a combination of various polymers and copolymers including polymer moieties or chains of polymerized maleic anhydride monomer units, polymer moieties or chains of polymerized N-subsituted maleimide monomer units, polymer moieties or chains of polymerized vinyl aromatic monomer units, polymer moieties or chains of polymerized vinyl cyanide monomer units, block copolymer moieties or chains comprising polymerized blocks of at least one of the foregoing monomer units, random copolymers comprising polymerized portions of at least one of the foregoing monomer units and alternating copolymers comprising polymerized portions of at least one of the foregoing monomer units.

In some embodiments, the mixture comprising maleic anhydride and N-substituted maleimide can comprise about 20%, 25%, 30%, 35%, 40%, 45%, 50%, 55% or 60% by weight with reference to the total weight of the N-substituted maleimide copolymer. Further, according to some embodiments of the present invention, the mixture comprising maleic anhydride and N-substituted maleimide can comprise a weight percentage of the N-substituted maleimide copolymer in a range from about any of the foregoing amounts to any other of the foregoing amounts.

In some embodiments, the mixture comprising a vinyl aromatic compound and/or a vinyl cyanide compound can comprise about 40%, 45%, 50%, 55%, 60%, 65%, 70%, 75% or 80% by weight with reference to the total weight of the N-substituted maleimide copolymer. Further, according to some embodiments of the present invention, the mixture comprising a vinyl aromatic compound and/or a vinyl cyanide compound can comprise a weight percentage of the N-substituted maleimide copolymer in a range from about any of the foregoing amounts to any other of the foregoing amounts.

In some embodiments, the vinyl aromatic compound is not present in the N-substituted maleimide copolymer. Also, in some embodiments, the vinyl cyanide compound is not present in the N-substituted maleimide copolymer.

Examples of the N-substituted maleimide include N-methyl maleimide, N-ethyl maleimide, N-propyl maleimide, N-butyl maleimide, N-pentyl maleimide, N-n-hexyl maleimide, N-lauryl maleimide, N-stearyl maleimide, N-cyclohexyl maleimide, N-phenyl maleimide, N-methoxy phenyl maleimide, N-methyl phenyl maleimide, N-dimethyl phenyl maleimide, N-ethyl phenyl maleimide, N-diethyl phenylmaleimide, N-phenoxy phenyl maleimide, N-carboxy phenyl maleimide, N-tolylmaleimide, N-hydroxymaleimide, N-benzylmaleimide and combinations thereof.

Examples of the vinyl cyanide compound include acrylonitrile, methacrylonitrile and combinations thereof. Examples of the vinyl aromatic compound include styrene, alpha-methylstyrene, o-methylstyrene, p-methylstyrene, m-methylstyrene, p-t-butylstyrene, 2,4-dimethylstyrene, 2,4,6-trimethylstyrene, vinyltoluene, 1-vinylnapthalene, 2-vinylnapthalene, vinyl anthracene, 1,3-dimethylstyrene, and combinations thereof.

In some embodiments of the present invention, the N-substituted maleimide copolymer can comprise about 1%, 5%, 10%, 15%, 20%, 25%, 30% or 35% by weight with reference to the total weight of the thermoplastic resin composition. Further, in some embodiments of the present invention, the N-substituted maleimide copolymer can comprise a weight percentage of the thermoplastic resin composition in a range from about any of the foregoing amounts to about any of the other of the foregoing amounts.

Additional Components

In some embodiments, the thermoplastic resin composition can optionally include additives such as oxidation inhibitors, lubricants, impact modifiers, light stabilizers, fillers and pigments.

Preparing the Thermoplastic Resin Composition

As described above, another aspect of the present invention relates to a method of preparing the foregoing thermoplastic resin composition. This method includes providing a diene graft polymer; providing a first vinyl cyanide-vinyl aromatic copolymer group having a first weight average molecular weight; providing a second vinyl cyanide-vinyl aromatic copolymer group having a second weight average molecular weight; providing a N-substituted maleimide copolymer; and mixing the diene graft polymer, the first and second vinyl cyanide-vinyl aromatic copolymer groups and the N-substituted maleimide copolymer. The method can further include other steps, such as providing other additives such as oxidation inhibitors, lubricants, impact modifiers, light stabilizers, fillers and pigments, extruding the resin composition, or molding the resin composition into a shape.

According to some embodiments of the present invention, the above components are mixed together all at once. Alternatively, one or more of the components can be added individually.

Formulating and mixing the components can be accomplished by any method known to persons having ordinary skill in the art. The mixing may occur in a pre-mixing state in a device such as a ribbon blender, followed by further mixing in a Henshel mixer, Banbury mixer, a single screw extruder, a twin screw extruder, a multi screw extruder, or a cokneader.

Articles Made From the Thermoplastic Resin

As described above, another aspect of the present invention relates to articles made from the foregoing thermoplastic resin composition embodiments. The resin composition can be extruded or can be molded using various moldings such as a mold box or a melt-molding device. Further, in some embodiments of the present invention, the thermoplastic resin composition can be formed into pellets. According to some embodiments, the pellets can then be molded into various shapes using, for example injection molding, injection compression molding, extrusion molding, blow molding, pressing, vacuum forming or foaming. In some embodiments, the resin composition can be made into pellets using a melt-kneader.

In some embodiments of the present invention, the thermoplastic resin composition can be formed into various structural parts. In some embodiments, the resin composition can be formed into various automotive body or automotive structural parts such as bumpers, spoilers, fenders, license plates and license plate frames. In some embodiments, the resin composition can be formed into various parts for appliances.

The invention may be better understood by reference to the following examples which are intended for the purpose of illustration and are not to be construed as in any way limiting the scope of the present invention. In the following examples, all parts and percentage are by weight unless otherwise indicated.

### EXAMPLES

The components of the examples were prepared in the following fashion:

Preparation of Diene Graft Polymer

58 parts by weight of butadiene rubber was added to 100 parts by weight of monomer mixture consisting of 25% by weight of acrylonitrile and 75% by weight of styrene, followed by grafting in emulsion polymerization to obtain graft ABS resin of core-shell type with a rubber particle size of 0.3 μm.

Preparation of the First Vinyl Cyanide-Vinyl Aromatic Copolymer Group

An α-methylstyrene-acrylonitrile copolymer having an average molecular weight of 120,000 and comprising 28% by weight of acrylonitrile and 72% by weight of α-methylstyrene was used.

Preparation of the Second Vinyl Cyanide-Vinyl Aromatic Copolymer Group

A styrene-acrylonitrile copolymer having a weight average molecular weight of 300,000 and comprising 28% by weight of acrylonitrile and 72% by weight of styrene was used.

Preparation of N-Substituted Maleimide Copolymer

N-substituted maleimide copolymer consisting of 50% by weight of styrene, 49% by weight of N-phenyl maleimide and 1% by weight of maleic anhydride, and having a weight average molecular weight of 160,000 was used.

### Examples 1-4

The components as shown in Table 1 were mixed and the mixture was extruded together with 0.1 part by weight of octadecyl-3-(4-hydroxy-3,5-di-tert-butylphenyl) propionate as an antioxidant, 0.3 parts by weight of calcium stearate as a lubricant and 0.02 parts by weight of dimethyl polysiloxane as an impact modifier through a twin screw extruder with L/D=29 and Φ=45 mm in pellets. The cylinder temperature of the extruder was kept at 240° C. Test specimens for flowability and physical properties were prepared. Test specimens for measuring the coefficient of linear thermal expansion were prepared in a size of 1×1×0.3 cm. The content of volatile organic compound (VOC) was measured by means of gas chromatography. Test results are shown in table 2.

### Comparative Example 1

Comparative Example 1 was conducted in the same manner as in Example 1 except that the content of the diene graft polymer was changed to 13 parts by weight and that of the α-methylstyrene-acrylonitrile copolymer was changed to 32 parts by weight.

### Comparative Example 2

Comparative Example 2 was conducted in the same manner as in Example 1 except that the content of diene graft polymer was changed to 32 parts by weight and that of the styrene-acrylonitrile copolymer was changed to 13 parts by weight.

### Comparative Example 3

Comparative Example 3 was conducted in the same manner as in Example 1 except that the content of the α-methylstyrene-acrylonitrile copolymer was changed to 65 parts by weight and that of the styrene-acrylonitrile copolymer was changed to 5 parts by weight.

### Comparative Example 4

Comparative Example 4 was conducted in the same manner as in Example 1 except that the content of N-substituted maleimide copolymer was changed to 35 parts by weight and that of the a-methylstyrene-acrylonitrile copolymer was changed to 20 parts by weight.

### Comparative Example 5

Comparative Example 5 was conducted in the same manner as in Example 1 except that N-substituted maleimide copolymer was not used and the content of the α-methylstyrene-acrylonitrile copolymer was changed to 55 parts by weight.

TABLE 1

| | | | α-methyl | | |
|---|---|---|---|---|---|
| | | Diene | styrene- | styrene- | N-substituted |
| | | graft | acrylonitrile | acrylonitrile | maleimide |
| | | polymer | copolymer | copolymer | copolymer |
| Examples | 1 | 20 | 45 | 25 | 10 |
| | 2 | 25 | 45 | 20 | 10 |
| | 3 | 20 | 30 | 40 | 10 |
| | 4 | 20 | 45 | 20 | 15 |
| Comparative | 1 | 13 | 45 | 32 | 10 |
| Examples | 2 | 32 | 45 | 13 | 10 |
| | 3 | 20 | 65 | 5 | 10 |
| | 4 | 20 | 20 | 25 | 35 |
| | 5 | 20 | 55 | 25 | — |

Discussion of Examples

The mechanical properties of the the test specimens of Examples 1-4 and Comparative Examples 1-5 were measured as follow:

(1) The notch Izod impact strength was measured in accordance with ASTM D256 (¼″ notched, 23° C.

(2) The melt flow index was determined in accordance with ISO 1133 (10 kg, 220° C.).

(3) The heat distortion temperature (HDT) was measured according to ASTM D648 (¼″, 120° C./hr) under 18.5 kgf/cm².

(4) The coefficient of linear thermal expansion was measured by thermomechanical analyzer (TMA), varying the temperature from 30° C. to 80° C. at the rate of 10° C./min.

(5) Total content of volatile organic compound (TVOC) was measured by using gas chromatography in accordance with VDA 277.

The test results of Examples 1-5 and Comparative Examples 1-5 are shown in Table 2.

TABLE 2

| | | Izod | | | coefficient of | |
|---|---|---|---|---|---|---|
| | | impact | | | linear thermal | |
| | | strength | melt flow | | expansion | |
| | | (kgf · | index | HDT | (μm/m · | TVOC |
| | | cm/cm) | (g/10 min) | (° C.) | ° C.) | (ppm) |
| Exam- | 1 | 10 | 3.0 | 100 | 68 | 209 |
| ples | 2 | 14 | 2.8 | 99 | 71 | 215 |
| | 3 | 11 | 3.0 | 100 | 67 | 172 |
| | 4 | 9 | 2.5 | 102 | 70 | 164 |
| Compar- | 1 | 5 | 3.5 | 101 | 64 | 198 |
| ative | 2 | 19 | 2.0 | 97 | 79 | 212 |
| Exam- | 3 | 7 | 3.1 | 102 | 70 | 295 |
| ples | 4 | 6 | 1.5 | 112 | 67 | 157 |
| | 5 | 8 | 2.7 | 95 | 68 | 314 |

As shown in Table 2, the composition of Comparative Example 1 which contained the diene graft polymer less than 15 parts by weight showed a low coefficient of linear thermal expansion but exhibited poor impact strength. The composition of Comparative Example 2 which contained the diene graft polymer more than 30 parts by weight showed high coefficient of linear thermal expansion and good impact strength. The composition of Comparative Example 3 in which the ratio of the α-methylstyrene-acrylonitrile copolymer to the styrene-acrylonitrile copoloymer was 13 showed poor impact strength. The composition of Comparative Example 4 which contained N-substituted maleimide copolymer more than 30 parts by weight showed both impact strength and flowability were inferior. And, the composition of Comparative Example 5, in which the N-substituted maleimide copolymer was absent showed inferior heat resistance and increased volatile organic compound content. The present invention can be easily carried out by an ordinary skilled person in the art. Many modifications and changes may be deemed to be with the scope of the present invention as defined in the following claims.

What is claimed is:

1. A thermoplastic resin composition comprising:
a diene graft polymer comprising a rubber polymer grafted with polymeric chains of at least one of a vinyl cyanide monomer and a vinyl aromatic monomer;
a first vinyl cyanide-vinyl aromatic copolymer group having a weight average molecular weight from about 100,000 to 200,000;
a second vinyl cyanide-vinyl aromatic copolymer group having a weight average molecular weight from 200,000 to about 600,000; and
an N-substituted maleimide copolymer.

2. The composition of claim 1, wherein the diene graft polymer is from about 15% to about 30% by weight with reference to the total weight of the composition.

3. The composition of claim 1, wherein the total amount of the first and second vinyl cyanide-vinyl aromatic copolymer groups is from about 40% to about 84% by weight with reference to the total weight of the composition.

4. The composition of claim 1, wherein the weight ratio of the first vinyl cyanide-vinyl aromatic copolymer group to the second vinyl cyanide-vinyl aromatic copolymer group is less than about 4.

5. The composition of claim 1, wherein the N-substituted maleimide copolymer is from about 1% to about 30% by weight with reference to the total weight of the composition.

6. The composition of claim 1, wherein the N-substituted maleimide copolymer is from about 8% to about 18% by weight with reference to the total weight of the composition.

7. The composition of claim 1, wherein the composition is in the form of a molded article.

8. The composition of claim 7, wherein the molded article comprises a part of an automobile.

9. The composition of claim 1, wherein the diene graft polymer is from about 15% to about 30% by weight with reference to the total weight of the composition, wherein the total amount of the first and second vinyl cyanide-vinyl aromatic copolymer groups is from about 40% to about 84% by weight with reference to the total weight of the composition, wherein the N-substituted maleimide copolymer is from about 1% to about 30% by weight with reference to the total weight of the composition, and wherein the weight ratio of the first vinyl cyanide-vinyl aromatic copolymer group to the second vinyl cyanide-vinyl aromatic copolymer group is less than about 4.

10. The composition of claim 1, wherein a piece of the composition has an Izod impact strength of at least about 9 kgf·cm/cm when measured according to the standard ASTM D256 (¼″ notched) at 23° C.

11. The composition of claim 1, wherein a piece of the composition has a coefficient of linear thermal expansion smaller than about 72 μm/m·° C. when measured using a thermomechanical analyzer (TMA) under temperature varying from 30° C. to 80° C. at the rate of 10° C./min.

12. The composition of claim 1, wherein the composition has a total content of volatile organic compound (TVOC) smaller than about 300 ppm when measured using gas chromatography under VDA 277.

13. A method of making a shaped thermoplastic resin composition, the method comprising:
providing a mass of the composition of claim 1; and
molding the mass into a molded article.

14. The method of claim 13, wherein providing a mass comprises:
providing a diene graft polymer comprising a rubber polymer grafted with polymeric chains of at least one of a vinyl cyanide monomer and a vinyl aromatic monomer;
providing a first vinyl cyanide-vinyl aromatic copolymer group having a weight average molecular weight from about 100,000 to 200,000;
providing a second vinyl cyanide-vinyl aromatic copolymer group having a weight average molecular weight from 200,000 to about 600,000;
providing an N-substituted maleimide copolymer; and
mixing the diene graft polymer, the first vinyl cyanide-vinyl aromatic copolymer group, the second vinyl cyanide-vinyl aromatic copolymer group and the N-substituted maleimide copolymer to form a mass.

15. The method of claim 13, wherein the N-substituted maleimide copolymer is from about 1% to about 30% by weight with reference to the total weight of the composition.

16. The method of claim 13, wherein the N-substituted maleimide copolymer is from about 10% to about 15% by weight with reference to the total weight of the composition.

17. The method of claim 13, wherein the weight ratio of the first vinyl cyanide-vinyl aromatic copolymer group to the second vinyl cyanide-vinyl aromatic copolymer group is less than about 4.

18. The method of claim 13, wherein the molded article comprises a part of an automobile.

19. The method of claim 13, wherein the diene graft polymer is from about 15% to about 30% by weight with reference to the total weight of the composition, wherein the total amount of the first and second vinyl cyanide-vinyl aromatic copolymer groups is from about 40% to about 84% by weight with reference to the total weight of the composition, wherein the N-substituted maleimide copolymer is from about 1% to about 30% by weight with reference to the total weight of the composition, and wherein the weight ratio of the first vinyl cyanide-vinyl aromatic copolymer group to the second vinyl cyanide-vinyl aromatic copolymer group is less than about 4.

20. The method of claim 13, wherein the composition has a total content of volatile organic compound (TVOC) smaller than about 300 when measured using gas chromatography under VDA 277.
